(19) United States
(12) Patent Application Publication
(10) Pub. No.: US 2005/0114066 A1
(43) Pub. Date: May 26, 2005

(54) Method and apparatus for detecting and correcting invalid test definition data

(76) Inventors: Robert Stanley Kolman, Longmont, CO (US); Dan Ralph Enix, Boulder, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/722,183

(22) Filed: Nov. 24, 2003

(51) Int. Cl. G06F 19/00

(52) U.S. Cl. 702/119

(57) ABSTRACT

Methods and apparatus for detecting and correcting invalid test definition data in user input are disclosed. In one embodiment, apparatus includes computer readable media, and program code stored on the computer readable media. The program code has code to define a user interface, and code that interacts with the user interface. A first portion of code that interacts with the user interface detects invalid test definition data in user input and, upon detection of invalid test definition data, prompts a user to select a valid data option from a set of valid data options. The prompting is undertaken through the user interface. A second portion of code that interacts with the user interface receives a valid data option selected through the user interface, and updates the invalid test definition data with the valid data option. Methods and apparatus for compiling the set of valid data options are also disclosed.

### BACKGROUND

Prior to using a circuit test system, a user must typically provide the system with data that describes the specific application in which the test system is to operate. For example, in board test applications, a user must typically provide a description of the board to be tested, including descriptions of its pins, devices, node names, node connections and other characteristics. The user may also need to specify test activities (e.g. by defining test procedures, test sequences, and other events that need to be executed by the hardware or software of a test system). In system on a chip (SOC) applications, a user must typically provide a description of the device to be tested, including descriptions of its pin names and other characteristics. The user may also need to specify individual tests, test sequences, test flows, expected results, and tester behaviors when errors are encountered. In both of these contexts (and others), the “test definition data” provided by the user must be consistent and correct for a test system to behave as expected and desired. As a result, any errors in a user's data must be corrected.

User input to a test system is typically converted from a human readable form to more rigorously formed circuit test data structures. It is during this processing and conversion that a test developer must correct any errors found in his or her data (which errors may have been introduced, for example, by typing error, specification of an invalid data value, or selection of a data value that was not previously specified). Often, a computer process' detection of invalid data results in the process aborting, with a possible notification that invalid data has been detected in a certain line of code. Discerning the type of data that must be supplied to “cure” the error can be a laborious and time-consuming task.

### SUMMARY

In one embodiment, apparatus comprises computer readable media, and program code stored on the computer readable media. The program code comprises code to define a user interface, and code that interacts with the user interface. A first portion of code that interacts with the user interface detects invalid test definition data in user input and, upon detection of the invalid test definition data, prompts a user to select a valid data option from a set of valid data options. The prompting is undertaken through the user interface. A second portion of code that interacts with the user interface receives a valid data option selected through the user interface, and updates the invalid test definition data with the valid data option.

In another embodiment, a first computer-based method is provided. In accordance with the method, user input is parsed to detect invalid test definition data in the user input. Upon detection of invalid test definition data, a user is prompted to select a valid data option from a set of valid data options. Upon receiving the valid data option selected from the set of valid data options, the invalid test definition data is updated with the valid data option. Circuit test data structures to control an automated circuit tester are then generated.

In yet another embodiment, a second computer-based method is provided. In accordance with the method, source code for generating circuit test data structures is parsed to identify type name definitions and enumeration constant definitions contained in the source code. A string table is then generated from the identified type name and enumeration constant definitions. Thereafter, the string table is linked to an input validation and error messaging portion of the source code to 1) cause the source code to index the string table upon detection of invalid test definition data, and then 2) cause a set of valid data options retrieved from the string table to be displayed to a user for user selection.

Other embodiments of the invention are also disclosed.

### BRIEF DESCRIPTION OF THE DRAWINGS

Illustrative embodiments of the invention are illustrated in the drawings in which:

FIG. 1 illustrates a first exemplary apparatus that may be used to detect and correct invalid test definition data;

FIG. 2 illustrates a second exemplary apparatus that may be used to detect and correct invalid test definition data;

FIG. 3 illustrates an exemplary prompt provided by an exemplary user interface that may be used by the apparatus of FIGS. 2 and 3;

FIG. 4 illustrates an exemplary method for detecting and correcting invalid test definition data; and

FIG. 5 illustrates an exemplary method for compiling the data in a store of valid data options.

### DETAILED DESCRIPTION

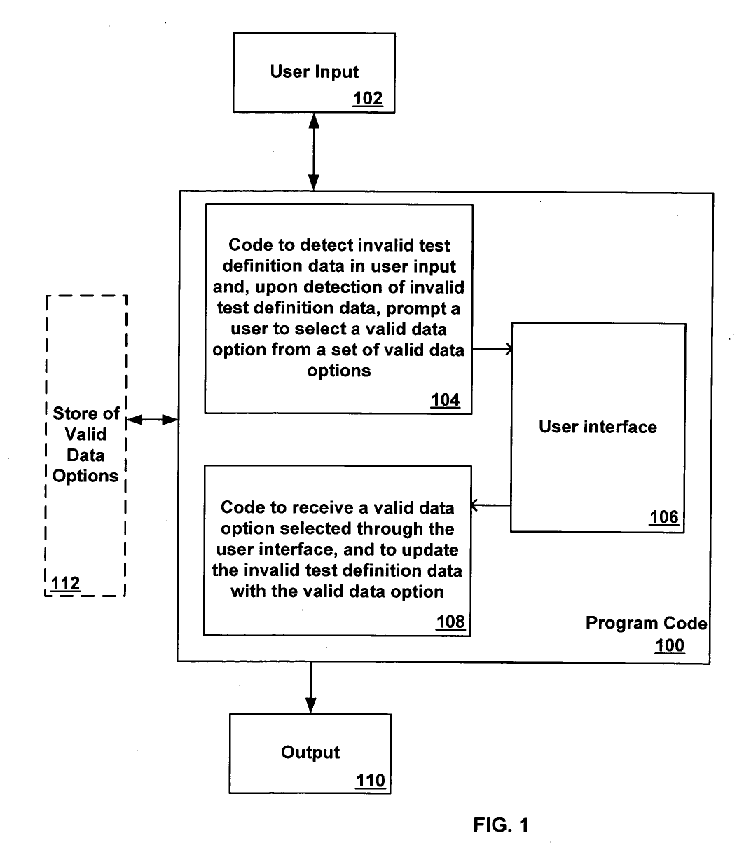

A first exemplary embodiment of apparatus that may be used to detect and correct invalid test definition data in user input is shown in FIG. 1. The apparatus comprises program code 100 stored on computer readable media. Program code 100 comprises code 104 to detect invalid test definition data in user input 102 that is being analyzed, converted and/or otherwise processed by the program code 100. Upon detection of invalid test definition data, the code 104 prompts a user to select a valid data option from a set of valid data options. This prompting is undertaken through a user interface 106 defined by the code 100. Program code 100 also comprises code 108 to 1) receive a valid data option selected through user interface 106, and then 2) update the invalid test definition data with the valid data option. By way of example, the updating of invalid test definition data may be undertaken by writing the valid data option back into a test definition file (user input 102) where the invalid test definition data was located, or by providing the valid data option as output 110 (which could be part of a file that is produced as the user input is analyzed, converted, etc.).

For purposes of this description, the phrases “user input” and “test definition data” are intended to cover data that is manipulated, as well as the commands or instructions that cause the data to be manipulated. User input 102 may be provided in various forms, and may be provided in the form of a test definition file (or files), or in the form of individual responses. User input 102 may also be provided to code 100 prior to launch of the code, or interactively (and possibly through a screen of user interface 106). Test definition data is defined herein to include any sort of data that is used to configure a circuit tester, such as the names of pins, devices, nodes, and node connections to be tested, as well as the types and sequences of tests to be executed by a circuit tester.

In one embodiment of the FIG. 1 apparatus, the program code 100 compiles a set of valid data options based on a context (e.g., a data type) of invalid data. For example, if the invalid data is expected to be an integer, the set of valid data options compiled by the code 100 might be a set of valid integers. Or, for example, if the invalid data is expected to be a color, the set of valid data options might be a set of colors.

Although a set of valid data options could be generated “on the fly” when invalid data is detected, it will often be preferable to compile and store valid data options in advance. The apparatus shown in FIG. 1 is therefore shown with an optional store 112 of valid data options. In one embodiment, the store 112 is organized as a string table, and valid data options are logged into the store 112 in accordance with a context (e.g., a data type, a list header, a tag, or some other sort of index means). For example, a set of valid colors might be logged in store 112, with “colors” being the context by which the code 100 indexes the store 112 to retrieve the set of valid colors. Similarly, a set of valid integers might be logged in store 112, with “integers” being the context by which the code 100 indexes the store 112 to retrieve the set of valid integers.

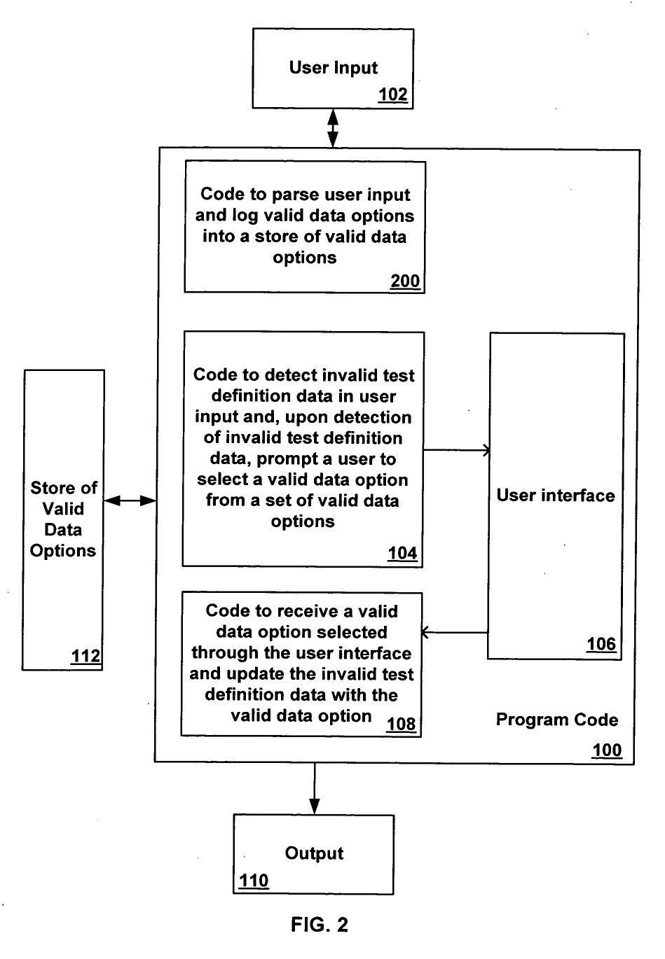

In addition to creating a store 112 of valid data options prior to when code 100 analyzes user input to detect invalid test definition data, a store 112 may also be generated or supplemented while the code 100 is analyzing user input. FIG. 2 therefore illustrates an alternate embodiment of the FIG. 1 apparatus, wherein the code 100 further comprises code 200 to parse the user input 102 and log valid data options into the store 112. It should be noted that the code 200 that logs valid data options into the store 112 and the code 104 to detect invalid test definition data in the user input may operate on user input 102 in parallel.

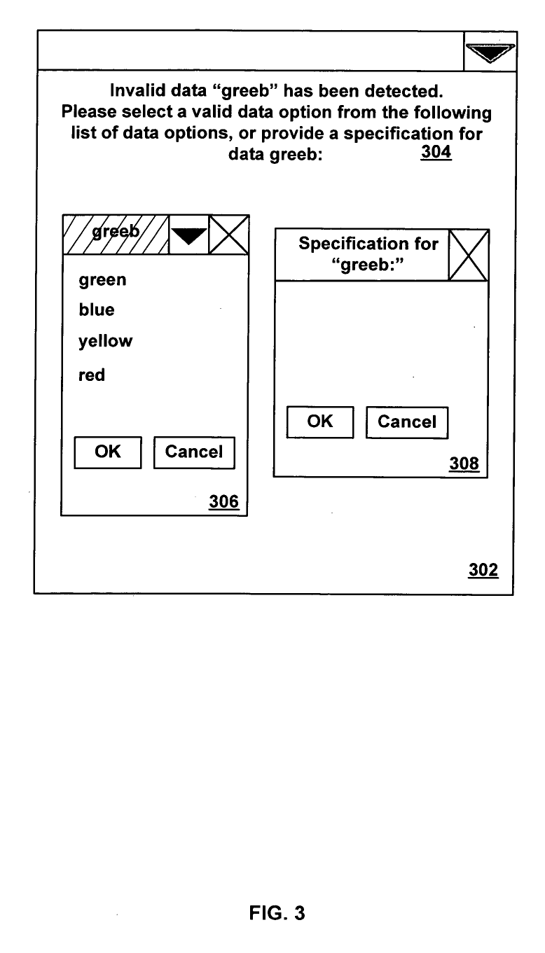

In the apparatuses described above, the code defining user interface 106 comprises code to configure how a set of valid data options is displayed. For example, the user interface 106 may generate a window 302 for 1) prompting a user that invalid has been detected (see prompt 304, FIG. 3), and 2) displaying a set of valid data options 306. The exemplary prompt 304 shown in FIG. 3 notifies a user that invalid data “greeb” has been detected. Based on the context of “greeb”, code 104 then prompts a user to select a valid data option from a drop-down list 306 comprising valid data options “green,” “blue,” “yellow,” and “red.” Alternately, the set of valid data options could be presented in other ways, such as a fully displayed (non-drop-down) list, a list of options associated with radio buttons, etc. It should also be noted that a “set” of valid data options could consist of a single option; or, upon detection of some invalid data items, there may not be any valid data options to present. This latter case (and others) may be addressed by providing an area in window 302 for a user to input a data option that does not appear within a computer-generated set of valid data options. For example, in window 302, the highlighted selection “greeb” may be replaceable by means of a user typing over the selection. Alternately, a set of valid data options could consist of only a single data option that is replaceable by a user.

The order of options in list 306 may be variously chosen, and may include an alphabetical ordering, ordering by highest likelihood of correctness, and so on. If ordering by highest likelihood of correctness is possible, code 100 may determine which option is most likely to be correct by, for example, pattern matching, determining which data option has appeared most frequently, determining which data option appeared most recently, etc. In one embodiment, user interface 106 provides a user with means (e.g., a menu option) to configure how valid data options are displayed in window 302 (e.g., alphabetically, etc.).

There may be instances when data that has been detected as invalid is invalid for want of a specification to make it valid. To address this issue, the user interface 106 may comprise code to define an input area 308 (FIG. 3) for receiving a specification (e.g., a data type) for the data item.

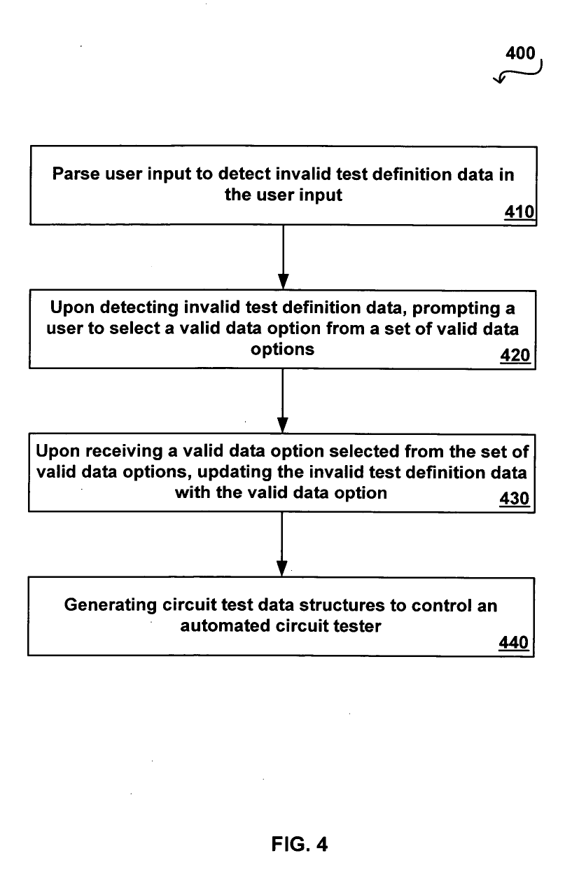

FIG. 4 illustrates a computer-based method 400 for detecting and correcting invalid test definition data in user input. The method 400 comprises parsing 410 user input to detect invalid test definition data in the user input. Upon detecting invalid test definition data, a user is prompted 420 to select a valid data option from a set of valid data options. In one embodiment, the set of valid data options may comprise a single valid data option that is replaceable by the user. Upon receiving the valid data option selected from the set of valid data options, the invalid test definition data is updated 430 with the valid data option. By way of example, this may comprise updating the status of the invalid data to valid upon receiving a specification for the data. Thereafter, circuit test data structures to control an automated circuit tester are generated 440.

As discussed with respect to user interface 106 (FIGS. 1 & 2), the set of valid data options may be displayed to a user in alphabetical order, in order of highest likelihood of correctness, or in other ways.

Method 400 may further comprise compiling a set of valid data options based on a context of invalid data. For example, the context of invalid data may be used to identify a number of valid data options that are defined for the context.

Method 400 may also comprise logging valid data options in a store of valid data options, and then deriving a set of valid data options from the store. When logging valid data options, each option may be logged in accordance with a context index so that it may later be compiled with other valid data options by conducting a search for data options associated with a particular context index.

By prompting a user with a set of valid data options upon the detection of invalid data, as variously shown in FIGS. 1-4, a user should be better able to quickly determine 1) whether the data detected as invalid is actually invalid, and 2) if the data is actually invalid, which of a number of valid data options might be the correct data option.

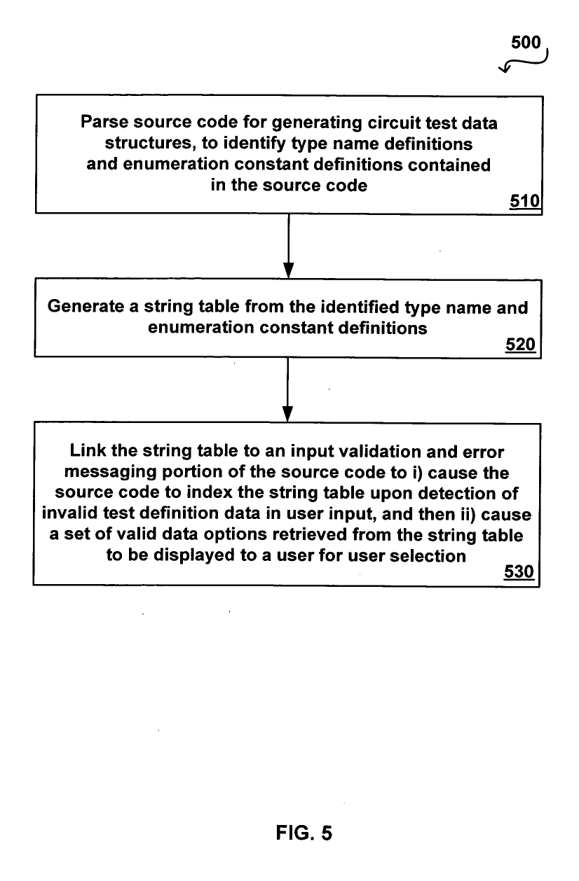

FIG. 5 illustrates a computer-based method 500 for compiling the data in a store of valid data options. The method starts with the receipt of source code for generating circuit test data structures. The source code may generate circuit test data structures by merely processing input files, or by prompting a user for additional input. The source code is parsed 510 to identify type name definitions (e.g., definitions for “integers” or “colors”) and enumeration constant definitions (i.e., the values that may be assumed by a data type) contained in the source code. A string table is then generated 520 from the identified type name and enumeration constant definitions. Thereafter, the string table is linked 530 to an input validation and error messaging portion of the source code to 1) cause the source code to index the string table upon detection of invalid test definition data in user input, and then 2) cause a set of valid data options retrieved from the string table to be displayed to a user for user selection. The FIG. 5 method may be implemented by program code that modifies a piece of source code so that the source code implements the invention described herein.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. Apparatus, comprising:
computer readable media; and
program code, stored on the computer readable media, comprising:
code to define a user interface;
code to detect invalid test definition data in user input and, upon detection of invalid test definition data, prompt a user to select a valid data option from a set of valid data options; said prompting being undertaken through the user interface; and
code to receive a valid data option selected through the user interface, and to update the invalid test definition data with the valid data option.

2. The apparatus of claim 1, wherein the program code further comprises code to compile the set of valid data options based on a context of the invalid test definition data.

3. The apparatus of claim 2, wherein the program code to compile the set of valid data options uses the context of the invalid test definition data to index a table of valid data options.

4. The apparatus of claim 3, wherein the program code further comprises code to parse the user input and log valid data options into said table.

5. The apparatus of claim 2, wherein said context comprises a data type.

6. The apparatus of claim 1, wherein at least some of said user input is received through said user interface.

7. The apparatus of claim 1, wherein at least some of said user input is contained in a test definition file.

8. The apparatus of claim 1, wherein the code that prompts a user to select a valid data option causes the set of valid data options to be displayed through the user interface in alphabetical order.

9. The apparatus of claim 1, wherein the code that prompts a user to select a valid data option causes the set of valid data options to be displayed through the user interface in order of highest likelihood of correctness.

10. The apparatus of claim 1, wherein the user interface comprises code to configure how the set of valid data options is displayed through the user interface.

11. The apparatus of claim 1, wherein the user interface comprises code to define an input area to receive a specification for invalid test definition data that has been detected as invalid because it lacks a specification to make it valid.

12. The apparatus of claim 11, wherein said input area to receive a specification for invalid test definition data is configured to receive a data type.

13. The apparatus of claim 1, wherein the set of valid data options comprises a single valid data option that is replaceable by the user.

14. A computer-based method, comprising:
parsing user input to detect invalid test definition data in the user input;
upon detecting invalid test definition data, prompting a user to select a valid data option from a set of valid data options;
upon receiving a valid data option selected from the set of valid data options, updating the invalid test definition data with the valid data option; and
generating circuit test data structures to control an automated circuit tester.

15. The method of claim 14, wherein parsing user input comprises parsing a test definition file.

16. The method of claim 14, further comprising compiling the set of valid data options based on a context of the invalid data.

17. The method of claim 14, wherein the set of valid data options is displayed to the user in alphabetical order.

18. The method of claim 14, wherein the set of valid data options is displayed to the user in order of highest likelihood of correctness.

19. A computer-based method, comprising:
parsing source code for generating circuit test data structures, to identify type name definitions and enumeration constant definitions contained in said source code;
generating a string table from said type name and enumeration constant definitions; and
linking said string table to an input validation and error messaging portion of said source code to i) cause said source code to index said string table upon detection of invalid test definition data in user input, and then ii) cause a set of valid data options retrieved from said string table to be displayed to a user for user selection.

20. The method of claim 19, wherein said index into said string table comprises a context of said invalid test definition data.
